(19) United States
(12) Patent Application Publication
(10) Pub. No.: US 2009/0230732 A1
(43) Pub. Date: Sep. 17, 2009

(54) VEHICLE ROOF

(75) Inventors: Jurgen Bayer, Weissach (DE); Kurt Pfertner, Friolzheim (DE); Conrad Hummel, Stuttgart (DE); Wolfgang Dittrich, Bietigheim-Bissingen (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/404,366

(22) Filed: Mar. 16, 2009

(30) Foreign Application Priority Data
Mar. 15, 2008 (DE) 10 2008 014 496.7

(51) Int. Cl. B60J 7/02

(52) U.S. Cl. 296/216.04

(57) ABSTRACT

A vehicle roof contains a first movable roof part, a guide device for displacing the first roof part relative to a second roof part for optionally at least partially opening and closing a roof opening. The guide device contains first and second lateral guide rails of a lateral guide and at least one third guide rail of a central guide, in which the first roof part is guided with front and rear slide bearings adjacent to its front and rear edges. In order to be able to increase further the comfort in a motor vehicle, it is provided that the front slide bearings are guided in the first and second guide rails of the lateral guide and the rear slide bearing is guided in the central guide.

### CROSS-REFERENCE TO RELATED APPLICATION

This application claims the priority, under 35 U.S.C. § 119, of German application DE 10 2008 014 496.7, filed Mar. 15, 2008; the prior application is herewith incorporated by reference in its entirety

### BACKGROUND OF THE INVENTION

### Field of the Invention

The invention relates to a vehicle roof containing a first movable roof part having front and rear edges, slide bearings including front slide bearings and a rear slide bearing, a second roof part, and a guide device for displacing the first roof part relative to the second roof part for optionally at least partially opening and closing a roof opening. The guide device has a lateral guide with first and second lateral guide rails and a central guide with at least one third guide rail, in which the first roof part is guided with the front and rear slide bearings adjacent to the front and rear edges.

Such a vehicle roof is known from published, non-prosecuted German patent application No. DE 10 2005 026 827 A1, corresponding to published U.S. patent application No. 2008/0258509, which contains a first and/or front movable roof part, which may be moved on a guide device relative to a second roof part. The guide device contains, as a lateral guide, first and second guide rails, which bear at the side externally against the second roof part in parallel and at a distance from one another in the longitudinal direction of the vehicle. The guide device also has a central guide which has a central web, on which a third guide rail is attached and extends from a windshield frame as far as the second roof part. The movable first roof part is guided in the three guide rails by slide bearings. A slide bearing for the central guide is provided adjacent to the front edge of the first roof part and slide bearings for the lateral guide are provided adjacent to the rear edge.

### SUMMARY OF THE INVENTION

It is accordingly an object of the invention to provide a vehicle roof that overcomes the above-mentioned disadvantages of the prior art devices of this general type, in which the comfort is improved for the vehicle passengers.

With the foregoing and other objects in view there is provided, in accordance with the invention, a vehicle roof. The vehicle roof contains a first movable roof part having front and rear edges, slide bearings including front slide bearings and a rear slide bearing, a second roof part, and a guide device for displacing the first movable roof part relative to the second roof part for optionally at least partially opening and closing a roof opening. The guide device has a lateral guide with first and second lateral guide rails and a central guide with at least one third guide rail. In the guide device, the first movable roof part is guided with the front and rear slide bearings adjacent to the front and rear edges. The front slide bearings are guided in the first and second guide rails of the lateral guide and the rear slide bearing is guided in the central guide.

The invention is characterized in that the front slide bearings, which are thus located adjacent to the front edge of the first roof part, are guided in the lateral guide rails and the rear slide bearing is guided in the central guide. As a result, it is possible to dispense with guide rails in the rear lateral region of the second roof part, whereby the headroom, in particular for passengers in the rear of the vehicle, is markedly increased. As a result, boarding the vehicle interior is simplified as the door cut-out is accordingly able to be enlarged upwards. The lateral guide rails may, therefore, merely extend to the side in the front region in the vicinity of the roof opening. The central guide with its third guide rail, however, merely requires an extension in the longitudinal direction along the second roof part. It is, therefore, not necessary to widen the central guide to the front as far as a windshield frame. Overall, as a result of shortened guide rails a weight gain may also be achieved relative to a vehicle roof according to the prior art. Moreover, with the arrangement of the slide bearings according to the invention, the roof opening may be opened as far as possible by the movable first roof part. It has also been shown that sufficient stability for the movable roof part is provided by the three-point guide with the two lateral guide rails and the central guide with one guide rail, thus formed, in particular when the roof part is located in an open position, in which it at least partially opens the roof opening.

Particularly preferred is an embodiment in which the second roof part is configured as a fixed roof surface. The roof surface is thus particularly advantageously suitable for receiving the guide rail for the central guide. In particular, it is provided that this guide rail is arranged on the outer roof surface of the second roof part, so that the vehicle roof according to the invention is a so-called externally guided sliding roof.

For increasing the comfort, in a preferred embodiment it may be provided that a central web is disposed below the central guide, which extends in the longitudinal direction. The central web, on the one hand, covers the guide rail disposed in the roof surface from below. On the other hand, it may receive at least one comfort element which may be, in particular, a roller blind as a sun shade, when the second roof part is at least partially configured to be at least partially transparent. Such a roller blind could be arranged for each vehicle passenger in the rear of the vehicle to the left and/or to the right separately on the central web and may be configured to be able to be extended and/or pulled out transversely to the longitudinal direction of the vehicle. Air guiding channels for supplying air through the air conditioning system may also be disposed in the central web. Other vehicle internal fittings, such as lighting, speakers, control elements, receptacles, electrical connections, etc. may naturally be provided as at least one such comfort element.

For a structurally simple solution it is provided in a preferred embodiment to arrange the lateral guide rails immovably on the vehicle roof, in particular to attach the lateral guide rails to lateral roof members or adjacent to lateral roof members. The guide rails thus preferably extend from a front transverse edge of the roof opening to a rear transverse edge of the roof opening, the rear transverse edge of the roof opening being formed by the second roof part.

According to a particularly preferred embodiment, the third guide rail for the central guide is arranged adjacent to the rear transverse edge of the roof opening and extends from there in the direction of the rear of the vehicle. Preferably, in this connection the guide rail is arranged immovably on the second roof part.

According to a further preferred embodiment, the central web may also extend beyond the roof opening, and thus also receive a comfort element for front vehicle passengers, as is already disclosed above for different comfort elements.

Variants of the first and/or second roof part are set forth, and according to which at least one of the roof parts may be at least partially configured to be at least partially transparent.

Other features which are considered as characteristic for the invention are set forth in the appended claims.

Although the invention is illustrated and described herein as embodied in a vehicle roof, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, top plan view of a partially shown motor vehicle containing a vehicle roof in a closed position according to the invention;

FIG. 2 is a diagrammatic, partial side view of the motor vehicle containing the vehicle roof in a partially opened position;

FIG. 3 is a diagrammatic, partial side view of the motor vehicle with the vehicle roof in a fully opened position; and

FIG. 4 is a diagrammatic, top plan view of the partial motor vehicle with the fully opened vehicle roof according to FIG. 3.

### DETAILED DESCRIPTION OF THE INVENTION

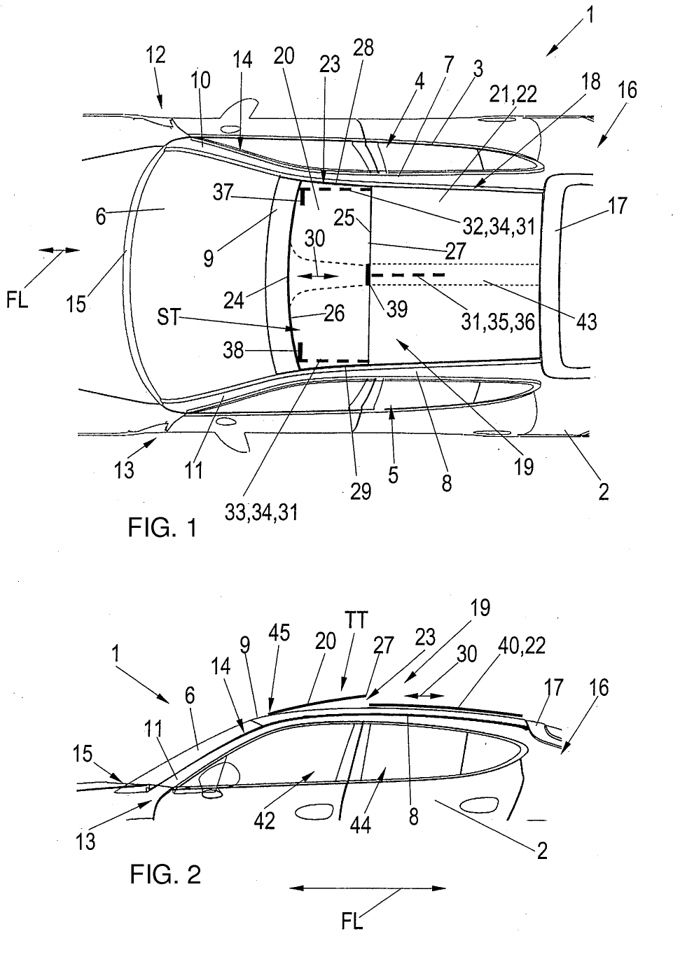

Referring now to the figures of the drawing in detail and first, particularly, to FIG. 1 thereof, there is shown a motor vehicle 1 from above with a body 2 which, above a waistline 3, has side vehicle windows 4 and 5 as well as a front window 6 also denoted as the windshield. The side windows 4 and 5 are framed above the waistline 3 by lateral longitudinal roof members 7 and 8 extending substantially in the longitudinal direction of the vehicle FL, which are connected to one another above the windshield 6 by a transversely extending frame piece 9. Between the waistline 3 and the frame piece 9 extend lateral extensions 10 and 11, which proceed from the A-pillars 12 and 13, also denoted as door pillars and extend in accordance with the definition as far as the frame piece 9. Thus the windshield 6 is surrounded by a windshield frame 14, which may be completed in the waistline 3 by a so-called lower cowl 15.

In the embodiment shown, the motor vehicle 1 has, between the lateral longitudinal roof members 7 and 8, the frame piece 9 of the windshield frame 14 and a rear region 16 which, in this case for example, begins with a partially shown tailgate 17, a roof cut-out 18 into which a vehicle roof 19 is inserted. In the embodiment shown, the roof cut-out 18 is defined by the lateral longitudinal roof members 7 and 8, the frame piece 9 and the rear region 16, in this case therefore the tailgate 17. It might also be conceivable, however, to provide the roof cut-out 18 in a fixed roof skin, which may be located between the longitudinal roof members 7 and 8, the frame piece 9 and the rear region 16. In the embodiment shown, the vehicle roof 19 is preferably prefabricated with its components as a module and inserted from below or above into the roof cut-out 18 and connected to the body 2 of the motor vehicle.

The vehicle roof 19 has a first and/or front roof part 20 and at least one rear and/or second roof part 21, which are positioned within the roof cut-out 18, located behind one another and/or in succession in the closed position ST shown in FIG. 1, and preferably adjacent to one another and flush with one another. The first roof part 20 is configured to be movable and may—proceeding from its closed position ST shown—be displaced at least in a linear manner to the rear in the direction of the vehicle rear 16. The second roof part 21 is configured in the embodiment as an immovable roof part which forms a fixed roof surface 22. Thus a roof opening 23 of the vehicle roof 19 is defined by a front transverse edge 24, a rear transverse edge 25 which may be formed from a front edge of the second roof part 21, and partially by the lateral longitudinal roof members 7 and 8. Consequently, the first roof part 20 has a front edge 26, a rear edge 27 as well as lateral edges 28 and 29.

For a linear displacement movement of the first roof part 20, which is identified in FIG. 1 by a double arrow 30 and which is oriented in the same direction as the vehicle longitudinal direction FL, a guide device 31 is associated with the vehicle roof 19 which—proceeding from the closed position ST shown—allows a displacement of the first roof part 20 overlapping the rear roof part 21, in order to be able to open the roof opening 23 optionally partially (partially open position TT) or fully (open position OT) and to be able to close said roof opening again in the reverse direction (closed position ST). To this end, the guide device 31 has lateral first and second lateral guide rails 32 and 33 of a so-called lateral guide 34 extending adjacent to the longitudinal roof members 7 and 8 or fastened thereto, extending in the longitudinal direction of the vehicle FL, as well as a central guide with a third and/or central guide rail 35. The third guide rail 35 is in this case approximately centrally attached between the two longitudinal roof members 7 and 8. The first and second guide rails 32 and 33 extend approximately from the front transverse edge 24 approximately as far as the rear transverse edge 25 of the roof opening 23, but they may project slightly over these edges. The third guide rail 35 extends—proceeding from the rear transverse edge 25—in the direction toward the vehicle rear 16 over a length which corresponds approximately to the length of the first roof part 20, this length being measured in the longitudinal direction of the vehicle FL. For supporting the first roof part 20 in the guide device 31, two front slide bearings 37 and 38 are provided, as well as a rear slide bearing 39. The three guide rails 32, 33 and 35 are illustrated in FIGS. 1 and 4 in dotted lines with a greater line thickness, and the slide bearings 37, 38 and 39 are recorded with the same line thickness. The three guide rails 32, 33 and 35 as well as the slide bearings 37, 38 and 39 are merely indicated schematically. Such slide bearings generally contain a non-illustrated sliding piece arranged in the guide rails, which is connected to the movable first roof part 20 via a lever arrangement, not shown, so that the roof part 20 may be raised or lowered from its position flush with the surface of the adjacent components, in order to convey it into the open position OT. Such slide bearings with lever arrangements are, however, known in the prior art so that further details will not be provided thereof.

Relative to the front edge 26 of the roof part 20, the front slide bearings 37 and 38 are arranged adjacent to the edge 26 on the roof part 20 so that they come to bear, in the closed position ST shown, approximately on the front rail end, not shown in more detail, of the guide rails 32 and 33. In the fully open position OT of the roof part 20 shown in FIG. 4, the slide bearings 37 and 38 are located approximately on the rear rail end of the guide rails 32 and 33. Relative to the rear edge 27 of the roof part 20, the rear central slide bearing 39 is arranged adjacent to this edge 27, which comes to bear in the closed position ST on the front rail end and in the fully open position OT (FIG. 4) comes to bear approximately on the rear rail end of the third guide rail 35.

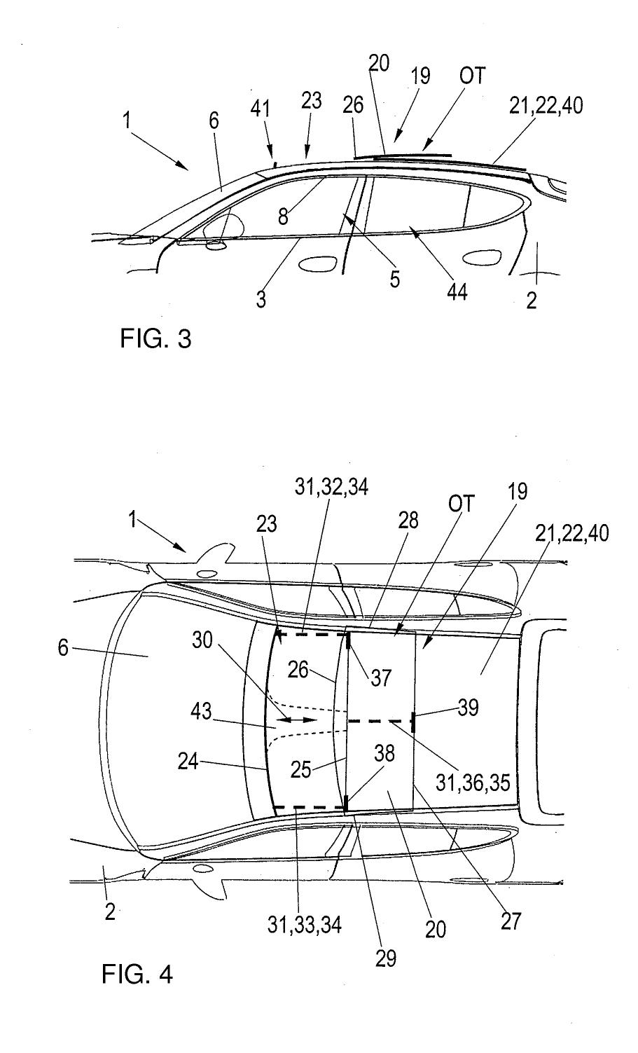

The first and second guide rails 32 and 33 are mounted fixedly on the vehicle roof 19 and/or on the longitudinal roof members 7 and 8. They are located, relative to a roof skin 40 of the vehicle roof 19 illustrated in FIG. 2 below the roof skin 40, whereas in one embodiment, the third guide rail 35 may be located in the roof skin 40 and preferably externally in the roof surface 22 of the second roof part 21. In this case, the first roof part 20 might be externally guided and may be located in the open position OT, as FIGS. 3 and 4 show, above the second roof part 21. According to a further embodiment it might be an alternative that the first roof part 20 does not come to bear—as described above—externally on the roof surface 22 in the open position, but is moved below the level of the roof skin 40. The third guide rail 35 of the central guide 36 would thus be arranged on an underside and/or inner surface of the second roof part 21, and the first roof part 20 would be pushed under the roof skin 40, i.e. moved into a vehicle interior 42. The displacement movement according to arrow 30 would, however, be identical.

From FIG. 3 it is also visible that the vehicle roof 19 may optionally be fitted with a fixed or movable i.e. extendable wind deflector 41 about which, however, further details will not be provided here, as such wind deflectors are known in the prior art.

In FIG. 4 a so-called central web 43 may also be seen, which is illustrated in dotted lines. It extends in the longitudinal direction of the vehicle FL and may extend over a substantial length of the vehicle roof 19. It is shown that it may extend, approximately proceeding from the frame piece 9 of the windshield frame 14, considerably far back in the direction of the vehicle rear 16. If the motor vehicle 1 is configured with a vehicle interior 42 with a vehicle rear 44, the central web 43 may be provided continuously. The central web 43 may receive one or more comfort elements (not shown).

In FIG. 2 the partially open position TT of the first roof part 20 is also shown, in which the first roof part 20 is positioned and/or raised with its rear edge 27 about a pivot axis 45 extending in the transverse direction of the vehicle. This partially open position TT is also passed when the first roof part 20 is moved from the closed position ST in the direction of the fully open position OT and vice versa. Naturally, further partially open positions of the roof part 20 may be adopted which are located between the partially open position TT illustrated in FIG. 2 and the fully open position OT and/or between the fully closed position ST and the partially open position TT. The same applies if the first roof part 20 in the open position OT is not located above—as shown in FIG. 3—but below the roof skin 40 which is described above. For increasing the comfort, the two roof parts 20 and 21 or one thereof may be partially configured to be at least partially transparent, for example as a glass cover.

1. A vehicle roof, comprising:
a first movable roof part having front and rear edges;
slide bearings including front slide bearings and a rear slide bearing;
a second roof part; and
a guide device for displacing said first movable roof part relative to said second roof part for optionally at least partially opening and closing a roof opening, said guide device having a lateral guide with first and second lateral guide rails and a central guide with at least one third guide rail, in said guide device said first movable roof part is guided with said front and rear slide bearings adjacent to said front and rear edges, said front slide bearings are guided in said first and second guide rails of said lateral guide and said rear slide bearing is guided in said central guide.

2. The vehicle roof according to claim 1, wherein said second roof part is configured as a fixed roof surface.

3. The vehicle roof according to claim 1, further comprising a middle central web disposed below said central guide, extending in a longitudinal direction.

4. The vehicle roof according to claim 1, wherein said central guide is disposed with said third guide rail on an external face of said second roof part.

5. The vehicle roof according to claim 1, further comprising lateral roof members, said first and second guide rails are disposed immovably on or adjacent to said lateral roof members of the vehicle roof.

6. The vehicle roof according to claim 1, wherein said first and second roof parts define a front transverse edge and a rear transverse edge, respectively, and said front transverse edge and said rear transverse edge define said roof opening therebetween, said first and second guide rails extend between said front transverse edge and said rear transverse edge of said roof opening.

7. The vehicle roof according to claim 6, wherein said third guide rail of said central guide has a front edge disposed adjacent to said rear transverse edge of said roof opening.

8. The vehicle roof according to claim 1, wherein said third guide rail of said central guide is disposed immovably on said second roof part.

9. The vehicle roof according to claim 3, further comprising a central web extending over a substantial length of the vehicle roof and receives at least one comfort element.

10. The vehicle roof according to claim 1, wherein at least one of said first movable roof part and said second roof part are at least partially configured to be one of transparent and partially transparent.

11. The vehicle roof according to claim 1, further comprising a roof skin and said central guide is disposed with said third guide rail on said roof skin.
